(19) United States
(12) Patent Application Publication
(10) Pub. No.: US 2021/0156348 A1
(43) Pub. Date: May 27, 2021

(54) Tank Closing Structure

(71) Applicant: AISAN KOGYO KABUSHIKI KAISHA, Obu-shi (JP)

(72) Inventor: Yasuyuki Yamaguchi, Ichinomiya-shi (JP)

(73) Assignee: AISAN KOGYO KABUSHIKI KAISHA, Obu-shi (JP)

(21) Appl. No.: 17/093,329

(22) Filed: Nov. 9, 2020

(30) Foreign Application Priority Data
Nov. 25, 2019 (JP) 2019-212043

(51) Int. Cl. F02M 37/10; F02M 37/00

(52) U.S. Cl. CPC F02M 37/103; F02M 37/0011

(57) ABSTRACT

A tank closing structure includes a tank body configured to store a liquid, a lid member that closes an opening formed in the tank body and has a liquid swelling property, and a holding ring that holds a flange portion of the lid member on the tank body. The tank closing structure further includes a deformation promoting portion for promoting deformation in which a radially central portion of the lid member is recessed inward of the tank body in response to the swelling of the lid member.

### CROSS-REFERENCE TO RELATED APPLICATIONS

This application claims priority to Japanese patent application serial number 2019-212043 filed November 25, 2019, the contents of which is incorporated herein by reference in its entirety for all purposes.

### BACKGROUND

Embodiments of the present disclosure relate generally to tank closing structures. Some tank closing structures include a tank body that stores liquid fuel, a lid member that closes an opening in the tank body, and a holding member that secures the outer peripheral portion of the lid member to the tank body. For example, the outer peripheral portion of the lid member may be fixedly held between the tank body and the holding member. The lid member may be made of, for example, resin and may swell due to absorption of fuel in the tank body.

### SUMMARY

In accordance with a first aspect of the present disclosure, a tank closing structure comprises a tank body, a lid member, and a holding member. The tank body may store a liquid such as fuel. The lid member may close an opening formed in the tank body and may have a liquid swelling property. The holding member may hold an outer peripheral portion of the lid member on the tank body. The tank closing structure may further include a deformation promoting portion configured to promote a deformation of the lid member in which the central portion of the lid member in the radial direction may be recessed inward of the tank body due to the swelling of the lid member.

According to the first aspect, the swelling deformation of the lid member may be promoted by the deformation promoting portion, to relieve the stress concentration due to the swelling deformation of the lid member.

In accordance with a second aspect of the present disclosure, the deformation promoting portion of the tank closing structure may be an inclined surface. The inclined surface may be formed on the surface of the holding member that faces the outer peripheral portion of the lid member. In addition, the inclined surface may be inclined so as to gradually separate from the lid member in a radially outward direction from the inside to the outside.

According to the second aspect, in regards to the swelling deformation of the lid member, the outer peripheral portion of the lid member may be configured to easily tilt toward the inclined surface of the holding member. As a result, the swelling deformation of the lid member may be promoted.

In accordance with a third aspect of the present disclosure, the deformation promoting portion of the tank closing structure may be a projection. The projection may project from at least one of the facing surfaces of the outer peripheral portion of the lid member and/or the holding member. In addition, the projection may be configured as a fulcrum for inclining the radial inner side of the lid member in a direction away from the holding member, due to the deformation of the lid member.

According to the third aspect, in regards to the swelling deformation of the lid member, the outer peripheral portion of the lid member may be configured to easily tilt, with at least one projection of the lid member and/or the holding member acting as the fulcrum. As a result, the swelling deformation of the lid member may be promoted.

In accordance with fourth aspect of the present disclosure, the deformation promoting portion of the tank closing structure may be configured to direct an elastic force of a sealing member, which is positioned between the tank body and the outer peripheral portion of the lid member, in a radially inward direction of the lid member.

According to the fourth aspect, the elastic force of the sealing member directed radially inward due to the deformation promoting portion may be configured to promote the swelling deformation of the lid member.

In accordance with a fifth aspect of the present disclosure, the deformation promoting portion of the tank closing structure may be an outer pressing portion that may be formed on the surface of the tank body facing the sealing member. In addition, the outer pressing portion may press a radially outer portion of the sealing member.

According to the fifth aspect, the elastic force of the sealing member may be directed radially inward of the lid member due to the outer pressing portion of the tank body. As a result, the swelling deformation of the lid member may be promoted.

In accordance with a sixth aspect of the present disclosure, the deformation promoting portion may be an inclined surface. The inclined surface may be formed on the surface of the tank body that faces the sealing member. In addition, the inclined surface may be inclined so as to gradually separate from the lid member in a radially inward direction from the outside to the inside.

According to the sixth aspect, the elastic force of the sealing member may be directed radially inward of the lid member due to the inclined surface of the tank body. As a result, the swelling deformation of the lid member may be promoted.

In accordance with seventh aspect of the present disclosure, the deformation promoting portion may be an inner pressing portion. The inner pressing portion may be formed on the surface of the outer peripheral portion of the lid member that faces the sealing member. In addition, the inner pressing portion may press a radially inner portion of the sealing member.

According to the seventh aspect, the elastic force of the sealing member may be directed radially inward of the lid member due to the inner pressing portion formed on the surface of the lid member that faces the sealing member. As a result, the swelling deformation of the lid member may be promoted.

According to the embodiments described in the present disclosure, the concentration of stress due to the swelling deformation of the lid member may be relieved.

### BRIEF DESCRIPTION OF THE DRAWINGS

FIG. 1 is a cross-sectional side view of an embodiment of a peripheral portion of a fuel supply device for a fuel tank in accordance with the principles described herein.

FIG. 2 is a plan view of the closing structure of the fuel tank of FIG. 1.

FIG. 3 is a perspective exploded view of the cam lock mechanism of FIG. 1.

FIG. 4 is an enlarged partial cross-sectional view of a deformation promoting portion according to a first embodiment.

FIG. 5 is an enlarged partial cross-sectional view illustrating a swelling deformation state of the lid member of FIG. 4.

FIG. 6 is an enlarged partial cross-sectional view of a deformation promoting portion according to a second embodiment.

FIG. 7 is an enlarged partial cross-sectional view illustrating a swelling deformation state of the lid member of FIG. 6.

FIG. 8 is an enlarged partial cross-sectional view of a deformation promoting portion according to a third embodiment.

FIG. 9 is an enlarged partial cross-sectional view illustrating a swelling deformation state of the lid member of FIG. 8.

FIG. 10 is an enlarged partial cross-sectional view of a deformation promoting portion according to a fourth embodiment.

FIG. 11 is an enlarged partial cross-sectional view illustrating a swelling deformation state of the lid member of FIG. 10.

FIG. 12 is an enlarged partial cross-sectional view of a deformation promoting portion according to a fifth embodiment.

FIG. 13 is an enlarged partial cross-sectional view illustrating a swelling deformation state of the lid member of FIG. 12.

FIG. 14 is an enlarged partial cross-sectional view of a deformation promoting portion according to a sixth embodiment.

FIG. 15 is an enlarged partial cross-sectional view illustrating a swelling deformation state of the lid member of FIG. 14.

### DETAILED DESCRIPTION

As previously described, some tank closing structures include a tank body that stores liquid fuel, a lid member that closes an opening in the tank body, and a holding member that secures the outer peripheral portion of the lid member to the tank body. The portion of the lid member that faces the fuel in the tank may swell outwardly in the radial direction in which its diameter increases due to absorption of the fuel. On the other hand, the portion of the lid member that does not face the fuel in the tank may not swell or swell very little, since it is exposed to the outside air rather than the fuel in the tank. Therefore, the central portion of the lid member may deform so as to be recessed and pulled inward toward the tank body due to swelling of the lid member predominately on the side facing the fuel. Such deformation may be referred to herein as “swelling deformation.”

The swelling deformation of the lid member may induce stress acting on a stress concentration part such as the rim part and/or the corner part of the lid member. When the stress acting on the lid member is sufficiently large, the stress concentration part may be deformed, thereby causing a crack.

Therefore, there has been a need to relieve stress concentrations due to swelling deformation of lid members of a tank closing structures.

Embodiments of the present disclosure will be described with reference to the figures.

In a first embodiment, a closing structure of a fuel tank mounted on a vehicle, such as an automobile, will be described. Subsequently, embodiments of deformation promoting portions that can be used in connection with the closing structure will be described.

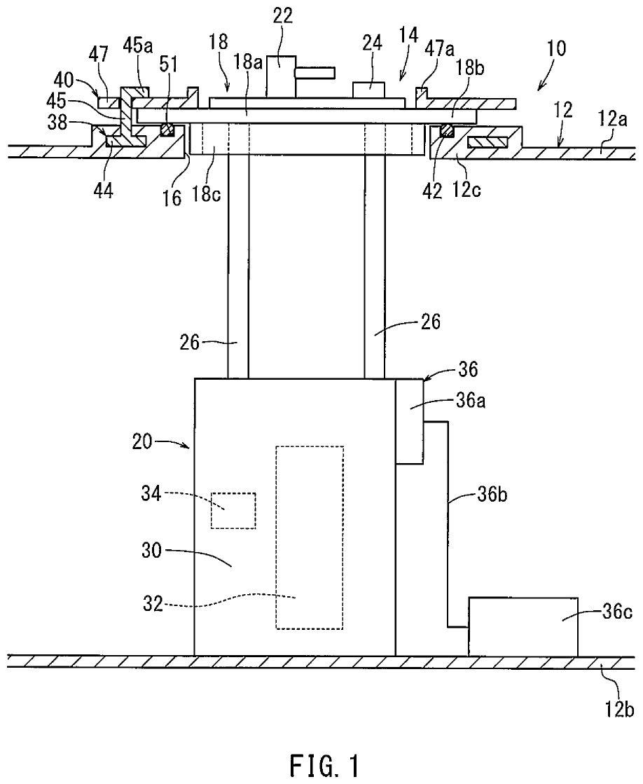

FIG. 1 is a cross-sectional view illustrating a peripheral portion of a fuel supply device of a fuel tank. For purposes of clarity and further explanation, the up-down and right-left directions as used and described herein are based on the orientation shown in FIG. 1. However, it should be appreciated that the arrangement direction of the fuel tank need not necessarily be so limited. The up-down direction in FIG. 1 corresponds to the direction of gravity in the state of being mounted on the vehicle, that is, the vertical direction.

As shown in FIG. 1, a fuel tank 10 includes a tank body 12 and a fuel supply device 14. The tank body 12 may be made of, for example, resin, and may be formed in a hollow container shape. The tank body 12 includes an upper wall 12a and a bottom wall 12b, which may both be horizontally oriented. An opening 16 in the shape of a circular hole is formed in the center of the upper wall 12a. The edge of the opening 16 in the upper wall 12a may be referred to as an opening edge 12c. The tank body 12 stores a liquid fuel. The fuel tank 10 may also be referred to herein as “the tank.”

The fuel supply device 14 includes a lid member 18 and a pump unit 20. The lid member 18 may be made of, for example, resin, and may have a liquid swelling property, and in particular, a fuel swelling property. The lid member 18 closes the opening 16 of the tank body 12. The lid member 18 is formed mainly of a lid body 18a. The lid body 18a has a disc shape. The outer peripheral portion of the lid body 18a includes a flange portion 18b having an outer diameter larger than the diameter of the opening 16 of the tank body 12. A fitting tubular portion 18c is provided on the lower surface of the lid body 18a. The fitting tubular portion 18c has a short tubular shape and is fitted into the opening 16 of the tank body 12. The lid body 18a includes a fuel discharge port 22, an electric connector 24, and the like. Two left and right guide rods 26 are attached to the lid body 18a and extend downward therefrom in a suspended manner. The flange portion 18b may also be referred to herein as “the outer peripheral portion.”

The lid member 18 is attached to the upper wall 12a, so as to close the opening 16 of the tank body 12. The fitting tubular portion 18c is fitted in the opening 16. The flange portion 18b is placed horizontally on the opening edge 12c. The flange portion 18b is held on the opening edge 12c by a holding ring 40. The closing structure of the fuel tank 10 for attaching the lid member 18 will be described later.

The pump unit 20 is inserted into the fuel tank 10 through the opening 16 prior to fitting the lid member 18 into the opening 16 of the tank body 12. The pump unit 20 includes a reservoir cup 30, a fuel pump 32, a pressure regulator 34, a sender gauge 36, and the like. The reservoir cup 30 is formed in a cylindrical shape, having an open top surface and a bottom portion. The reservoir cup 30 is placed on the bottom wall 12b of the fuel tank 10. The reservoir cup 30 is connected to both guide rods 26 of the lid member 18, so as to be vertically movable within a predetermined range. A biasing member, such as a coil spring, is interposed between the lid member 18 and the reservoir cup 30 and biases the lid member 18 and the reservoir cup 30 in opposite directions. Accordingly, the reservoir cup 30 may always be elastically biased and pressed against the bottom wall 12b of the fuel tank 10. Further, the fuel in the fuel tank 10 is transferred and stored in the reservoir cup 30 by a jet pump. The jet pump is operated by the pressurized fuel discharged from the fuel pump 32.

The fuel pump 32 is vertically held in the reservoir cup 30. A motor-integrated fuel pump may be used as the fuel pump 32. The fuel pump 32 is electrically connected to the electric connector 24 of the lid member 18. The fuel pump 32 uptakes, pressurizes, and discharges the fuel in the reservoir cup 30. The fuel discharge port of the fuel pump 32 is connected to the fuel discharge port 22.

The pressure regulator 34 adjusts the fuel pressure supplied to the engine to a predetermined pressure. The sender gauge 36 may be a fuel gauge sensor that detects the amount of fuel remaining in the fuel tank 10. The sender gauge 36 includes a gauge body 36a, an arm 36b, and a float 36c. The gauge body 36a is attached to the reservoir cup 30. The arm 36b is supported in a cantilever manner by a member on the rotation side of the gauge body 36a. The float 36c is attached to the free end of the arm 36b. The gauge body 36a is electrically connected to the electric connector 24 of the lid member 18.

As shown in FIG. 1, the closing structure of the fuel tank 10 includes a cap member 38, a holding ring 40, and a gasket 42. The cap member 38 may be made of, for example, metal, and includes an annular plate portion 44 and a locking piece 45. The annular plate portion 44 is formed in an annular plate shape, and is concentrically embedded in the opening edge 12c of the fuel tank 10.

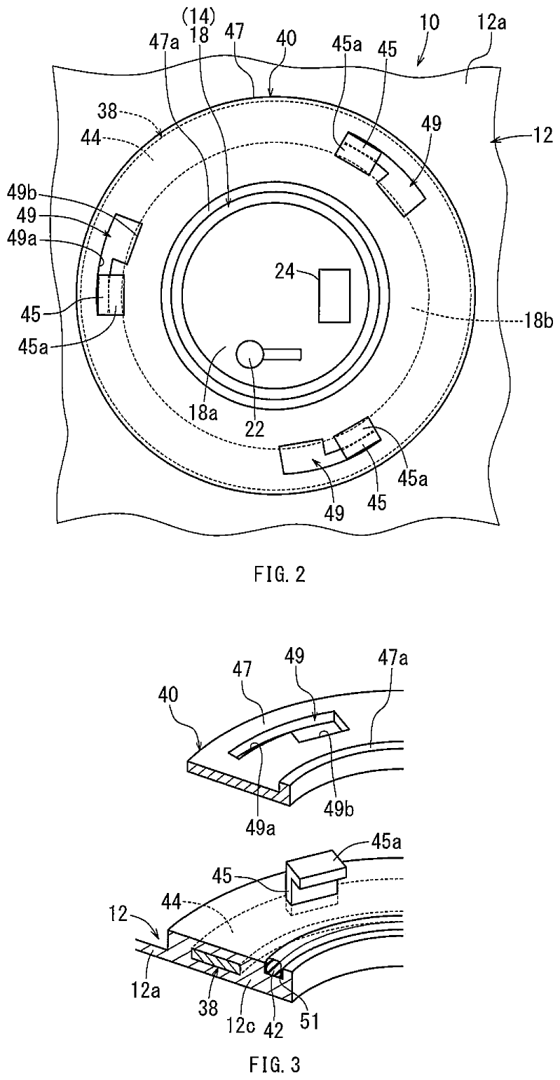

As shown in FIG. 2, a plurality of circumferentially-spaced locking pieces 45 (for example, three are shown in FIG. 2) are formed on the annular plate portion 44 at equal intervals in the circumferential direction. The locking piece 45 may be comprised of a part of a cam lock mechanism.

As shown in FIG. 3, the locking piece 45 is formed in the shape of a projecting piece that rises from the annular plate portion 44. A locking claw 45a, which projects radially inward in the radial direction of the annular plate portion 44, is formed at the tip (upper end) of the locking piece 45.

As shown in FIG. 1, the holding ring 40 may be made of, for example, metal, and is be formed mainly of a ring body 47 having an annular plate shape. A cylindrical edge portion 47a is formed on the inner peripheral edge portion of the ring body 47. The cylindrical edge portion 47a has a short cylindrical shape that is bent toward one side (upward) in the axial direction. The ring body 47 is formed with arcuate locking holes 49 in a number corresponding to the locking pieces 45 of the cap member 38 (see FIG. 2).

As shown in FIG. 3, the locking hole 49 includes a narrow portion 49a and a wide portion 49b (see FIG. 2). The narrow portion 49a extends in the circumferential direction. The wide portion 49b extends circumferentially from one end of the narrow portion 49a and is formed so as to widen radially inward relative to the narrow portion 49a (for example, the end portion on the clockwise direction side in the plan view). The cam lock mechanism, also referred to herein as a twist lock mechanism, functions as the attachment mechanism of the holding ring 40 and comprises the locking piece 45 and the locking hole 49. In general, the number of the locking pieces 45 and the locking holes 49 may be increased or decreased.

As shown in FIG. 1, a gasket groove 51 with an annular shape is concentrically formed on the upper surface of the opening edge 12c of the fuel tank 10 (see FIG. 3). The gasket groove 51 has a square cross sectional shape and is arranged on the inner peripheral side of the annular plate portion 44 of the cap member 38. The gasket 42 may be made of, for example, a rubber material having elasticity, and is disposed in the gasket groove 51. The holding ring 40 may also be referred to herein as “the holding member,” and the gasket 42 may also be referred to herein as “the sealing member.”

As shown in FIG. 1, when attaching the lid member 18 to the fuel tank 10, the lid member 18 is fitted into the opening 16 of the tank body 12. Specifically, the fitting tubular portion 18c of the lid member 18 is fitted into the opening 16, and the flange portion 18b is positioned over the annular plate portion 44 of the cap member 38.

Then, the wide portions 49b of the locking holes 49 of the holding ring 40 are positioned to allow the locking claws 45a of the locking pieces 45 of the cap member 38 to pass therethrough. After the locking claws 45a pass through the corresponding locking holes 49, the ring body 47 of the holding ring 40 is disposed on the flange portion 18b of the lid member 18.

Then, the holding ring 40 is rotated, in the clockwise direction in plan view, with the holding ring 40 pressed downward against the elasticity of the gasket 42. As a result, in each of the locking holes 49, each locking piece 45 is shifted from the wide portion 49b to the narrow portion 49a. Subsequently, the pressing force on the holding ring 40 may be released. Then, due to the elastic restoring force of the gasket 42, each of the locking claws 45a of the locking pieces 45 are brought into contact with or engaged with the corresponding edge portions of the narrow portions 49a of the locking holes 49. As a result, the holding ring 40 is prevented from coming off (see FIGS. 1 and 2).

The attachment of the lid member 18 is completed as described above. In the attached state, the flange portion 18b of the lid member 18 is held between the opening edge 12c of the fuel tank 10 and the ring body 47 of the holding ring 40. Further, the gasket 42 is interposed between the tank body 12 and the flange portion 18b of the lid member 18. The gasket 42 elastically seals the area between the opening edge 12c of the fuel tank 10 and the flange portion 18b of the lid member 18. The lid member 18 may be removed from the fuel tank 10 by performing the steps described above in the reverse order.

A fuel supply pipe, connected to the engine on one side, is connected to the fuel discharge port 22 of the lid member 18 in advance. An external connector connected to the engine control unit (ECU) is connected to the electric connector 24.

The fuel in the reservoir cup 30 is suctioned and pressurized by driving the fuel pump 32. The pressurized fuel is then be supplied to the engine via the fuel discharge port 22. The pressure of the fuel supplied to the engine may be adjusted to a predetermined pressure by the pressure regulator 34.

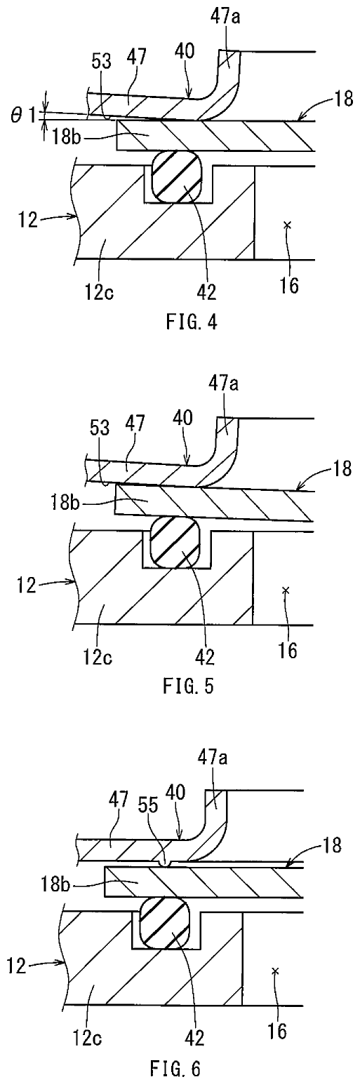

FIG. 4 is a cross-sectional view showing a first embodiment of a deformation promoting portion of a lid member. FIG. 5 is a cross-sectional view showing a swelling deformation state of the lid member. As shown in FIG. 4, the lower surface of the ring body 47 of the holding ring 40 includes an inclined surface 53, which may optionally be formed as a tapered surface. The inclined surface 53 is obliquely inclined in a direction that gradually separates from the facing surface (upper surface) of the flange portion 18b of the lid member 18 (upward) moving radially outward along the flange portion 18b. The inclined surface 53 is formed over the entire circumference of the ring body 47. The inclination angle 01 of the inclined surface 53 may be, for example, 1° to 3°. The inclined surface 53 may be formed by bending the ring body 47 upward, so that an angle relative to the cylindrical edge portion 47a is less than 90°. In this embodiment, the inclined surface 53 correspond to and defines “the deformation promoting portion.”

Due to the absorption of fuel, the lid member 18 may. The swelling may cause deformation (swelling deformation) resulting in the radially central portion of the lid member 18 to be recessed inward (downward) toward the tank body 12. Accordingly, the flange portion 18b of the lid member 18 may incline toward the inclined surface 53 of the holding ring 40 (see FIG. 5). Therefore, the swelling deformation of the lid member 18 in the desired and appropriate direction is promoted b the inclined surface 53. As a result, the stress concentration(s) due to the swelling deformation of the lid member 18 are relieved.

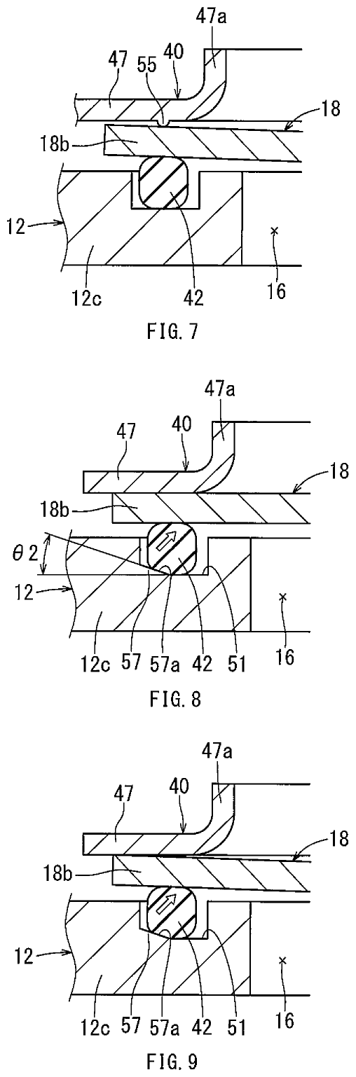

A second embodiment of a deformation promoting portion of a lid member is a modification of the deformation promoting portion(s) according to the first embodiment described above. Therefore, the modified portion(s) will be described in detail, while the portions substantially similar those of the first embodiment will be denoted by the same reference numerals and redundant description will be omitted. FIG. 6 is a cross-sectional view showing the deformation promoting portion of a lid member according to the second embodiment. FIG. 7 is a cross-sectional view showing a swelling deformation state of the lid member. As shown in FIG. 6, a ring body bead portion 55 extends continuously in an annular shape, and concentrically projects from the lower surface of the ring body 47 of the holding ring 40. The ring body bead portion 55 may contact the upper surface of the flange portion 18b of the lid member 18.

The ring body bead portion 55 is arranged at a position so that it may serve as a fulcrum for inclining the radially inner side of the flange portion 18b in the direction away from the ring body 47 of the holding ring 40 (downward) in response to the swelling deformation of the lid member 18 (see FIG. 7). The cross-sectional shape of the ring body bead portion 55 may be a semicircular shape. In this embodiment, the ring body bead portion 55 corresponds to and defines “the deformation promoting portion” or “the projection” in the present disclosure. The lower surface of the ring body 47 faces the flange portion 18b of the lid member 18. The cross-sectional shape of the ring body bead portion 55 is not limited to the semicircular shape, and may be changed to a triangular shape, a trapezoidal shape, or the like.

According to the second embodiment, the radially inner side of the flange portion 18b of the lid member 18 may easily tilt, with the ring body bead portion 55 of the holding ring 40 acting as a fulcrum in response to the swelling deformation of the lid member 18 (see FIG. 7), thereby promoting the swelling deformation of the lid member 18. As a result, the stress concentration(s) due to the swelling deformation of the lid member 18 are relieved.

A third embodiment of a deformation promoting portion of a lid member is a modification of the deformation promoting portion according to the first embodiment described above. Therefore, the modified portion(s) will be described in detail, while the portions substantially the same as those in the first embodiment will be denoted by the same reference numerals and redundant description will be omitted. FIG. 8 is a cross-sectional view showing the deformation promoting portion according to the third embodiment. FIG. 9 is a cross-sectional view showing a swelling deformation state of the lid member. As shown in FIG. 8, a ride-up portion 57 is formed on the outer peripheral portion of the bottom surface of the gasket groove 51 of the tank body 12. The ride-up portion 57 is a portion of the bottom surface where the radially outer portion of the gasket 42 rides.

The ride-up portion 57 includes a partly tapered inclined surface 57a that gradually inclines upward from the radially inner side toward the radially outer side. The inclination angle θ2 of the partly tapered inclined surface 57a may be, for example, 20°. The ride-up portion 57 is formed over the entire circumference of the bottom surface of the gasket groove 51. The ride-up portion 57 presses the radially outer portion of the gasket 42. In this embodiment, the ride-up portion 57 correspond to and defines “the deformation promoting portion” or “the outside pressing portion.” The bottom surface of the gasket groove 51 corresponds to the surface of the tank body 12 that faces the gasket 42. In addition, the cross-sectional shape of the partly tapered inclined surface 57a is not limited to a linear shape, but may be a concave arc shape, a convex arc shape, etc.

According to the third embodiment, the ride-up portion 57 of the tank body 12 directs the elastic force of the gasket 42 radially inward relative to the lid member 18 (see arrows in FIGS. 8 and 9). That is, the swelling deformation of the lid member 18 is promoted by the elastic force of the gasket 42, which is directed radially inward relative to the lid member 18 by the ride-up portion 57 (see FIG. 9). As a result, the stress concentration(s) due to the swelling deformation of the lid member 18 are relieved.

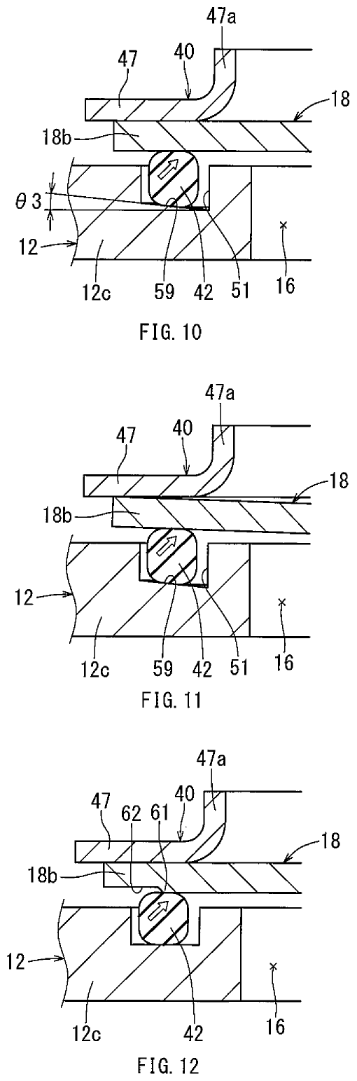

A fourth embodiment of a deformation promoting portion of a lid member is a modification of the deformation promoting portion according to the first embodiment described above. Therefore, the modified portion(s) will be described in detail, while the portions substantially the same as those in the first embodiment will be denoted by the same reference numerals and redundant description will be omitted. FIG. 10 is a cross-sectional view showing the deformation promoting portion according to the fourth embodiment. FIG. 11 is a cross-sectional view showing a swelling deformation state of the lid member. As shown in FIG. 10, a tapered inclined surface 59 is formed on the bottom surface of the gasket groove 51 of the tank body 12. The tapered inclined surface 59 gradually inclines upward from the radially inner side toward the radially outer side.

The inclination angle θ3 of the tapered inclined surface 59 may be, for example, 5°. The tapered inclined surface 59 is formed over the entire circumference of the bottom surface of the gasket groove 51. In this embodiment, the tapered inclined surface 59 correspond to and defines “the deformation promoting portion.” The bottom surface of the gasket groove 51 is the surface of the tank body 12 that faces the gasket 42. The cross-sectional shape of the tapered inclined surface 59 is not limited to a linear shape, but may be a concave arc shape, a convex arc shape, etc.

According to the fourth embodiment, the tapered inclined surface 59 of the tank body 12 direct the elastic force of the gasket 42 radially inward relative to the lid member 18 (see arrows in FIGS. 10 and 11). That is, the swelling deformation of the lid member 18 is promoted by the elastic force of the gasket 42, which is directed radially inward relative to the lid member 18 by the tapered inclined surface 59 (see FIG. 11). As a result, the stress concentration(s) due to the swelling deformation of the lid member 18 are relieved.

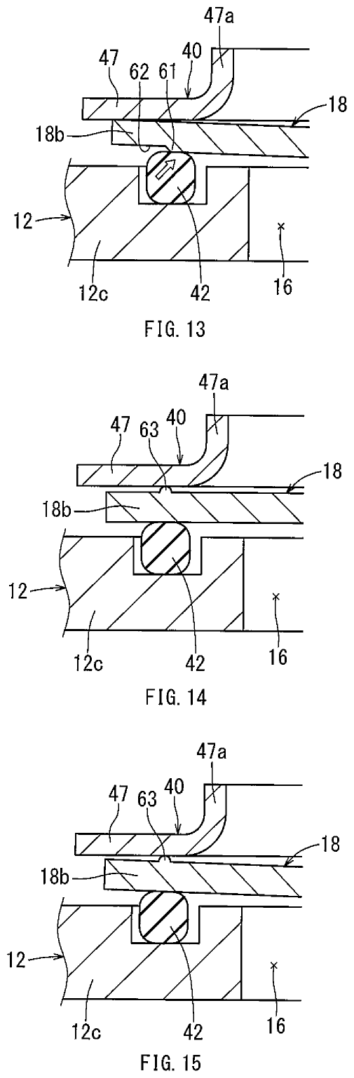

A fifth embodiment of a deformation promoting portion of a lid member is a modification of the deformation promoting portion according to the first embodiment described above. Therefore, the modified portion(s) will be described in detail, while the portions substantially the same as those in the first embodiment will be denoted by the same reference numerals and redundant description will be omitted. FIG. 12 is a cross-sectional view showing the deformation promoting portion according to the fifth embodiment. FIG. 13 is a cross-sectional view showing a swelling deformation state of the lid member. As shown in FIG. 12, a stepped portion 61 is formed on the lower surface of the flange portion 18b of the lid member 18. In this embodiment, the stepped portion 61 is forming by a concave surface 62, which raises the lower surface of the radially outer peripheral portion by one step.

The stepped portion 61 is formed over the entire circumference of the flange portion 18b. The stepped portion 61 is formed at a position facing an intermediate portion of the gasket 42 in the radial direction. The step portion 61 reduces the pressing force of the radially outer portion of the gasket 42, and increases the pressing force of the radially inner portion of the gasket 42. In this embodiment, the stepped portion 61 corresponds to and defines “the deformation promoting portion” or “the inside pressing portion.” The lower surface of the flange portion 18b faces the gasket 42.

According to the fifth embodiment, the stepped portion 61 formed on the flange portion 18b of the lid member 18 directs the elastic force of the gasket 42 radially inward relative to the lid member 18 (see arrows in FIGS. 12 and 13). That is, the swelling deformation of the lid member 18 is promoted due to the elastic force of the gasket 42, which is directed radially inward by the stepped portion 61 (see FIG. 13). As a result, the stress concentration(s) due to the swelling deformation of the lid member 18 are relieved.

A sixth embodiment of a deformation promoting portion of a lid member is a modification of the deformation promoting portion according to the first embodiment described above. Therefore, the modified portion(s) will be described in detail, while the portions substantially the same as those in the first embodiment will be denoted by the same reference numerals and redundant description will be omitted. FIG. 14 is a cross-sectional view showing the deformation promoting portion according to the sixth embodiment. FIG. 15 is a cross-sectional view showing a swelling deformation state of the lid member. As shown in FIG. 14, a lid member bead portion 63 is concentrically projects upward from the upper surface of the flange portion 18b of the lid member 18. The lid member bead portion 63 has a continuous annular shape. The lid member bead portion 63 may be in contact with the lower surface of the ring body 47 of the holding ring 40.

The lid member bead portion 63 is arranged at a position so as to serve as a fulcrum for inclining the radially inner side of the flange portion 18b in the direction away from the ring body 47 of the holding ring 40 (downward) in response to the swelling deformation of the lid member 18 (see FIG. 15). The cross-sectional shape of the lid member bead portion 63 is a semicircular shape. In this embodiment, the lid member bead portion 63 corresponds to and defines “the deformation promoting portion” or “the projection.” The upper surface of the flange portion 18b of the lid member 18 faces the ring body 47. The cross-sectional shape of the lid member bead portion 63 is not limited to the semicircular shape, but may be changed to a triangular shape, a trapezoidal shape, or the like.

According to the sixth embodiment, the radially inner side of the flange portion 18b of the lid member 18 may easily tilt, with the lid member bead portion 63 acting as a fulcrum, in response to the swelling deformation of the lid member 18 (see FIG. 15). Therefore, the swelling deformation of the lid member 18 is promoted. As a result, the stress concentration(s) due to the swelling deformation of the lid member 18 are relieved.

The embodiments disclosed in the present disclosure is not limited to the above-described embodiments, and can be implemented in various other forms. For example, the art disclosed in the present disclosure may be applied to a closing structure of a liquid tank other than the fuel tank 10, such as a water tank. Further, the attachment mechanism of the holding ring 40 is not limited to the cam lock mechanism, and may be appropriately changed to a screwing mechanism using a bolt or the like, a screwing mechanism for screwing the holding ring 40 to a member on the tank body 12 side, and the like. Furthermore, the deformation promoting portions (53, 55, 57, 59, 61, 63) of the embodiment may be used independently or in a combination of two or more.

The various examples described above in detail with reference to the attached drawings are intended to be representative of the present disclosure and are thus non-limiting embodiments. The detailed description is intended to teach a person of skill in the art to make, use, and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved tank closing structure, and/or methods of making and using the same.

What is claimed is:

1. A tank closing structure, comprising:
a tank body configured to store a liquid;
a lid member that closes an opening in the tank body and has a liquid swelling property;
a holding member holding an outer peripheral portion of the lid member on the tank body; and
a deformation promoting portion for promoting a deformation of the lid member in which a radially central portion of the lid member is recessed inward of the tank body in response to swelling of the lid member.

2. The tank closing structure of claim 1, wherein:
the deformation promoting portion comprises an inclined surface formed along a surface of the holding member,
the surface of the holding member faces the outer peripheral portion of the lid member, and
the inclined surface is inclined so as to gradually separate from the lid member moving radially outward along the inclined surface.

3. The tank closing structure according to claim 1, wherein:
the deformation promoting portion comprises a projection that projects from a surface of the outer peripheral portion of the lid member that faces the holding member, and
the projection is configured to serve as a fulcrum for inclining a radial inner side of the lid member in a direction away from the holding member due to the deformation of the lid member.

4. The tank closing structure according to claim 1, wherein:
the deformation promoting portion comprises a projection that projects from a surface of the holding member that faces the lid member, and
the projection is configured to serve as a fulcrum for inclining a radial inner side of the lid member in a direction away from the holding member due to the deformation of the lid member.

5. The tank closing structure according to claim 1, wherein:
the deformation promoting portion is configured to direct an elastic force of a sealing member radially inward toward the lid member, and
the sealing member is positioned between the tank body and the outer peripheral portion of the lid member.

6. The tank closing structure according to claim 5, wherein:
the deformation promoting portion comprises an outer pressing portion formed on a surface of the tank body that faces the sealing member, and
the outer pressing portion is configured to press a radially outer portion of the sealing member radially inward toward the lid member.

7. The tank closing structure according to claim 5, wherein:
the deformation promoting portion comprises an inclined surface formed on a surface of the tank body that faces the sealing member, and
the inclined surface is inclined so as to gradually separate from the lid member moving radially inward along the inclined surface.

8. The tank closing structure according to claim 5, wherein:
the deformation promoting portion comprises an inner pressing section formed on a surface of the outer peripheral portion of the lid member that faces the sealing member, and
the inner pressing section is configured to press a radially inner portion of the sealing member.

9. The tank closing structure according to claim 1, wherein the deformation promoting portion comprises an inclined surface formed on the outer peripheral portion of the lid member.

10. The tank closing structure according to claim 9, wherein:
the inclined surface of the outer peripheral portion of the lid member faces the tank body, and
the inclined surface is inclined so as to gradually separate from the tank body moving radially outward along the inclined surface.

11. The tank closing structure according to claim 9, wherein:
the inclined surface of the outer peripheral portion of the lid member faces the holding member, and
the inclined surface is inclined so as to gradually separate from the holding member moving radially outward along the inclined surface.
